(19) United States
(12) Patent Application Publication
(10) Pub. No.: US 2007/0126398 A1
(43) Pub. Date: Jun. 7, 2007

(54) Charging cradle, power supply components for providing said charging cradle with power, connector for said power supply component for connection of said charging cradle and charging system constituted of aforementioned components

(75) Inventors: Ralf Elting, Hamminkeln (DE); Stefan Maslow, Breckerfeld (DE); Johannes Veurman, Winterswijk (DE)

Correspondence Address: BELL, BOYD & LLOYD, LLP, P.O. BOX 1135, CHICAGO, IL, 60690, US

(73) Assignee: Siemens Aktiengesellschaft, Munich (DE)

(21) Appl. No.: 10/595,816

(22) PCT Filed: Jul. 30, 2004
(86) PCT No.: PCT/EP04/51666

§ 371 Date: May 12, 2006

(30) Foreign Application Priority Data
Nov. 28, 2003 (DE) 10355606.0

(51) Int. Cl. H02J 7/00

(52) U.S. Cl. 320/115

(57) ABSTRACT

The present disclosure relates to a charging cradle, a power supply component for providing the charging cradle with power, a connector for the power supply component for connection to the charging cradle; and to a charging system which is constituted of the aforementioned components. The aim of the present disclosure is to create an inexpensive and constructively adaptable charging possibility for mobile communication terminals The charging cradle used according to the present disclosure comprises only a housing in which contact springs are located. All other components are shifted into the power supply component, using a large surface connector which is provided with large surface contact areas for contact with the charging cradle.

### FIELD OF TECHNOLOGY

The present disclosure relates to a charging cradle for mobile communication terminals, a power supply component for supply of power to said charging cradle, a connector for said power supply component for connection to said charging cradle and a charging system for charging mobile communication terminals.

### BACKGROUND

Systems for charging mobile communication terminals are generally known. Such systems consist of a charging cradle and a power supply component, which is connected electromechanically via a flexible electrical lead either directly or with a detachable connector to the charging cradle. Charging cradles for charging mobile communication terminals are thus known per se in this context. Furthermore power supply components for operating the charging cradles are known per se in this context. Also known per se in this context are direct connections and also detachable connections between the charging cradle and the power supply component.

The disadvantage here is that manufacturing of the parts and of the charging systems formed from these parts is still too expensive. Increased effort is also required to adapt the parts used in the charging system to any constructional changes made in the mobile terminal. Document EP 1 296 421 A discloses a connector which is arranged within a charging cradle embodied as a self-contained component. The connector features a plug embodiment at its one free end and a socket embodiment at its other free end. Both embodiments are part of an overall housing of the connector, so that through them the connector is also embodied into a fully self-contained component. The connector is thus a very complicated part which is difficult and expensive to manufacture. When such a connector is fitted into an associated charging cradle, the charging cradle becomes difficult and expensive to manufacture. In addition, this connector makes adaptation to constructional changes in a device assigned to the charging cradle difficult and expensive regarding the contact spacings of the electrical connecting contacts since a completely newly constructed connector has to be used each time.

A power supply component for charging rechargeable batteries or accumulators is known from document GB 2 376 354 A. This case too merely involves a device delivering the necessary voltage for charging and featuring the corresponding electronics for this. The power supply component does not feature any electronics for control of the processes of charging a mobile communication terminal. As such, a power supply component the power supply component features a connector of which the electrical contacts are only embodied as small-surface contacts.

A connector is known from document U.S. Pat. No. 6,224,412 B1 which has large-surface contact areas on its surface such that these do not extend beyond a previously used conventional dimension.

### SUMMARY

Under an exemplary embodiment, a charging system is disclosed for charging mobile communication terminals, as well as a charging cradle and for operating the charging cradle a power supply component for use in the charging system, and as a connector for detachable connection between the charging cradle and said power supply component which makes to manufacture the relevant parts individually and all together and thereby the charging system at lower cost as well as to implement a simplified method of adaptation to constructive changes made to assigned mobile communication terminals, while simultaneously retaining simple handling for installation of the parts and furthermore of the charging system.

Under the embodiment, a charging cradle comprises a housing in which contact springs are arranged. The housing is assembled by simply snapping together two shaped sections. The contact springs are placed in one of the sections before the sections are snapped together.

For electrical connection of the charging cradle, one of the shaped sections features an insertion shaft into which a connector can be introduced and positioned.

An exemplary connector provides the electrical connection element via which the charging cradle is supplied with power. Large -surface contact areas of the connector are provided for making contact on introduction of the connector into the insertion shaft of the one shaped section of the housing with spring tongues at the one end of the contact springs. At the other end of the contact springs there are contact points provided, with which mating points on a mobile communication terminal which has been placed in the charging cradle for the purpose of charging can make contact through openings in the housing.

The fact that the charging cradle consists of these few simple components and has no permanent electrical power connection, means that it can be manufactured and assembled at low cost using simple methods. In addition it can be easily set up initially without a cable and subsequently connected with an electrical connecting cable. Electrical connection with the electrical connecting cable can be undertaken just as easily since the connecting cable without the charging cradle permanently connected to it is small and light, so that it can be routed without any problems behind cabinets and through small openings.

Adapting the charging cradle to constructional changes in the mobile terminal assigned to the charging cradle, especially with regard to the spacing of the mating contacts of the mobile communication terminal from each other can be undertaken in a simple manner by arranging the contact springs of the charging cradle correspondingly wide apart. Accordingly, no account need be taken of complex components within the charging cradle. Such complex components, or for that matter any other components, are not present in the charging cradle. Only a uniquely-shaped section for the half of the charging cradle concerned is required, with the insertion shaft for the connector able to remain unchanged, since the change to the spacing of the contact points of the contact springs, thereby the spacing change of the contact springs and the spacing change of the contact tongues for contacting the contact surfaces of the connector can be provided by the large surface of the contact areas of the connector without changing the connector.

An exemplary power supply component is further disclosed for supplying power to the charging cradle. The power supply component groups together in a single housing all the electronics and the control for the electronics for the purposes of charging a mobile communication terminal and is connected via a connecting cable with a connector with large-surface contact areas for contacting a charging cradle.

The power supply component is hardly any more expensive than a power supply component which does not also simultaneously contain the complete electronics and the entire control for charging a mobile communication terminal, because the electronics control components can be integrated into the electronics for the current and voltage transformation, which is present in any event in the power supply component. Few if any additional assembly steps are thus necessary to integrate this electronics and this control into the power supply component. The material costs too only increase slightly since the electronic components needed to make these changes can be placed at the same time on the existing base plate for the existing electronics.

However, the aforementioned power supply component provides in manufacturing a charging cradle, since no circuit board with electronics for charging and control of the charging of a mobile communication terminal has to be provided. Furthermore a large-surface connector connected to the power supply component has the advantage of being not significantly more expensive if any more expensive at all than a conventional connector. It does however have the particular advantage of being able to be provided with large-surface contact areas, which in their turn have the advantage of being able, without being modified in any way themselves, of allowing for changes with regard to the spacing of the contact springs of a charging cradle. Even if this makes the power supply component a little more expensive overall, significantly greater costs can still be saved with the power supply component in relation to an associated charging cradle. Greater cost savings can also be made in relation to the power supply component, since the large-area contact surfaces of the power supply component connector make it significantly more universal in its uses.

An exemplary connector is further disclosed, which comprises a large-surface base unit, on the surface of which large-surface contact areas are provided for making contact with a charging cradle. Extending the surface of the contact areas on the surface of the connector for making contact with a charging cradle means that the precise spacing the contact springs of the charging cradle which contact the contact surfaces of the connector is not so important as far as the charging cradle is concerned. This can thus also be varied without the connector having to be modified.

An exemplary charging system is also disclosed for charging mobile communication terminals, comprising a charging cradle as described above, a power supply component as described above and a connector as described above. The advantages of such a charging system stem from the advantages of the individual components, which are able to be found in the description of the individual components.

Position holders are formed into at least one of the shaped parts of the housing of the charging cradle, which help to position and to fix the contact springs which are to be fitted into the charging cradle during their assembly and also afterwards.

Also, the housing of the power supply component is connected directly to an AC power plug. This means that the power supply component can simultaneously assume a further function, namely that of an AC power adapter. At the same time this means that the power supply component is tidied away after use and is not lying around in the room on its own.

The flat design of the connector makes it unobtrusive. Starting bevels on its flat contact surfaces allow the contact springs such as would be present in the charging cradle previously mentioned to slide down onto their mating surfaces.

Guides on the surface of the connector, on opposite surface of the connector to the contact surfaces of the connector for example, help the connector to find its end position when it is being plugged in.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates an exploded view of a charging cradle under an exemplary embodiment;

FIG. 2 illustrates a power supply component in accordance with a further embodiment;

FIG. 3A illustrates a connector in accordance with the power supply component of FIG. 2, in a three-dimensional view from above;

FIG. 3B illustrates a connector in accordance with the power supply component of FIG. 2, in a three-dimensional view from below;

FIG. 3C is an exploded view of an exemplary connector;

FIG. 4A is a three-dimensional view of the base of a charging cradle as shown in FIG. 1;

FIG. 4B is a three-dimensional internal view of a shaped part forming the base plate of the charging cradle shown in FIG. 1; and

FIGS. 5A to 5C is a sequence of movements for a process of inserting the connector shown in one of the FIGS. 3A to 3C into a charging cradle shown in FIG. 1.

### DETAILED DESCRIPTION

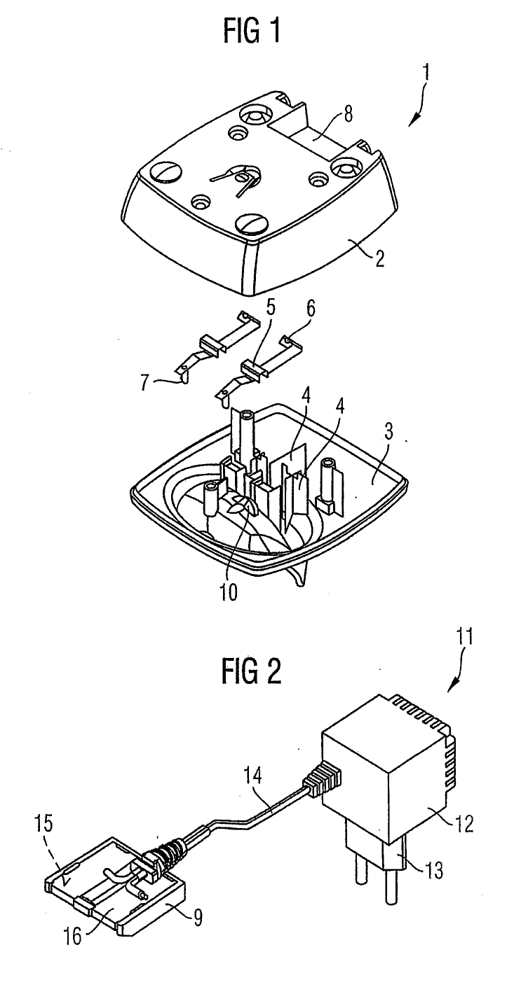

The charging cradle 1 as shown in FIG. 1 comprises two shaped parts 2 and 3, of which shaped part 2 forms a base plate and shaped part 3 forms a cover plate. Together the shaped parts 2 and 3 form a housing of the charging cradle 1. Shaped parts 2 and 3 are embodied so that they are able to be simply snapped together to form a housing.

In accordance with the present exemplary embodiment, one of the features of shaped part 3 is position holders 4 for contact springs 5.

Before the two shaped parts 2 and 3 are connected to each other, the contact springs 5 are inserted into the position holders.

The contact springs 5 feature contact tongues 6 at their one end and contact points 7 at their other end.

Shaped part 2 features a guide shaft 8 into which a connector 9 (FIG. 2) can be introduced and is able to be positioned.

The contact points 7 are able to be contacted through openings 10 of shaped part 3 by a mobile communication terminal to be charged which is placed in the charging cradle 1 by its corresponding contact points. The contact tongues 6 are gripped from below by a connector 9 introduced into the guide shaft 8 (FIG. 2) and thereby contacted.

The power supply component 11 shown in FIG. 2 comprises a power adapter and charging component as a complete electronics unit to which an ac power plug 13 is fitted directly.

The power supply component 11 features a connecting cable 14 to the end of which the connector 9 is attached.

The connector 9 has large surfaces and in accordance with the present exemplary embodiment and is preferably a flat design. On its upper side it has large-surface contact areas 15. On its base side it has at least a single guide 16.

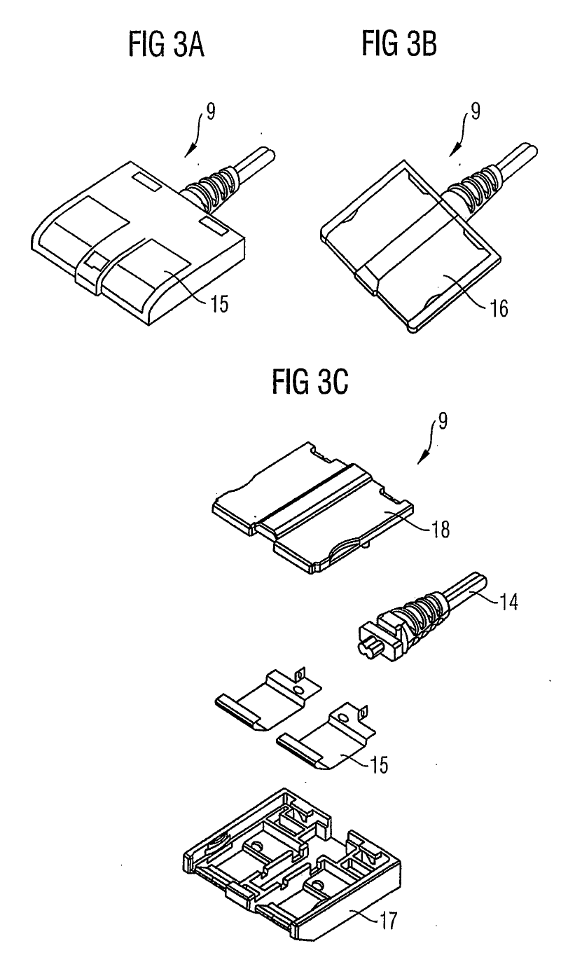

FIGS. 3A and 3B show views of the upper side and the base of the connector 9 respectively. The large-surface contact areas 15 can especially be seen in FIG. 3A and the guides 16 in FIG. 3B.

In accordance with FIG. 3B the connector 9 features two guides 16 which are preferably formed as concave guide channels.

FIG. 3C shows the connector 9 with its individual components. In particular the diagram shows the connecting cable 14, an upper section 17, a base section 18 and the large-surface contact areas 15.

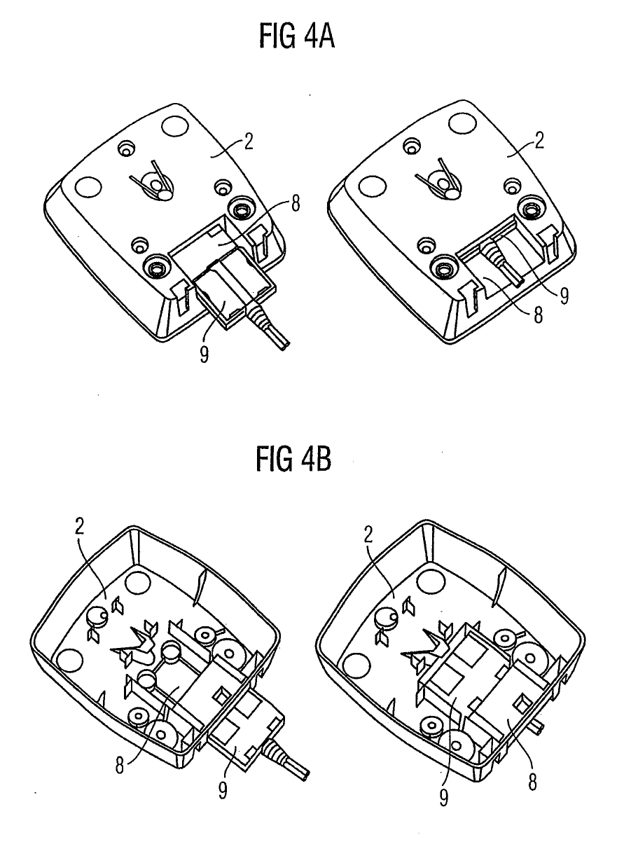

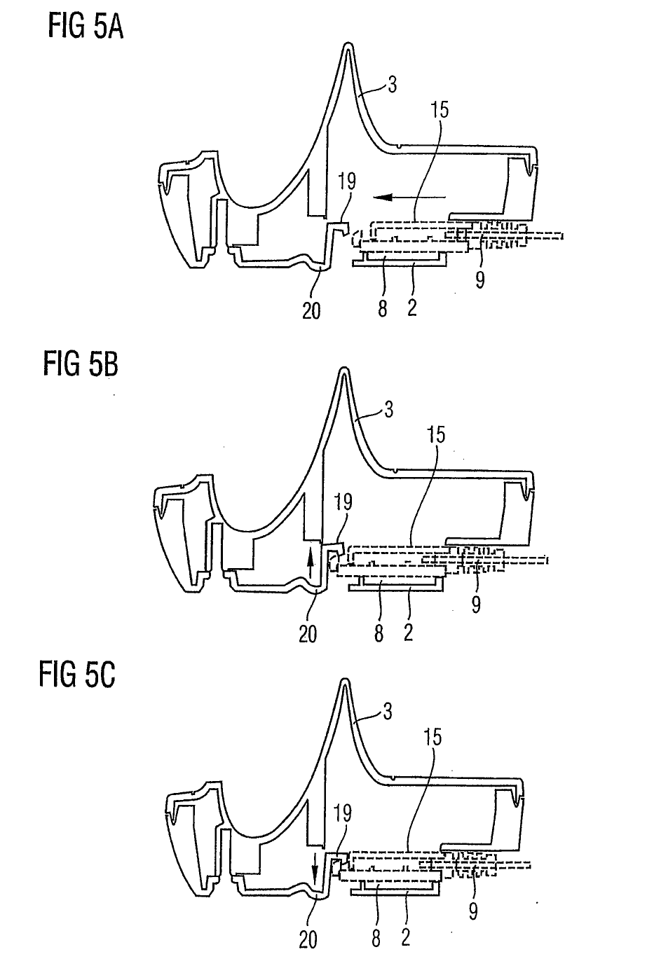

FIG. 4A shows the shaped part 2 in two time situations in which the connector 9 is being introduced into the guide shaft 8.

FIG. 4B again shows the time situations, but viewed looking into the shaped part 2.

1-9. (canceled)

10. A charging cradle for charging mobile communication terminals, comprising:
a housing, said housing comprising a guide shaft and contact springs, said contact springs being coupled on one end to spring tongues;
a connector, comprising contact areas, wherein said connector is inserted into said guide shaft to provide contact between the contact areas and another end of the contact springs; and
an opening in said housing, wherein said opening provides access for mating points on a mobile terminal to couple to said contact areas.

11. A charging cradle in accordance with claim 10, wherein the housing further comprises position holders formed within the housing upon which said contact springs are mounted.

12. A charging cradle in accordance with claim 10, further comprising a power supply component, provided within said housing and coupled to said connector for providing power.

13. A charging cradle in accordance with claim 12, wherein the power supply component is coupled to an AC power source.

14. A charging cradle in accordance with claim 10, wherein the contact areas are substantially flat and arranged on a forward area of the connector.
